(19) United States
(12) Patent Application Publication
(10) Pub. No.: US 2007/0160049 A1
(43) Pub. Date: Jul. 12, 2007

(54) METHOD AND APPARATUS FOR EFFECTING A HANDOFF IN A MOBILE INTERNET PROTOCOL COMMUNICATION SYSTEM

(75) Inventors: Qiaobing Xie, South Barrington, IL (US); Yogesh B. Bhatt, Schaumburg, IL (US); Ajoy K. Singh, Round Lake, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/618,947

(22) Filed: Jan. 2, 2007

Related U.S. Application Data
(60) Provisional application No. 60/757,272, filed on Jan. 9, 2006.

(51) Int. Cl. H04L 12/56

(52) U.S. Cl. 370/390; 370/395.52; 370/395.3

(57) ABSTRACT

A communication system provides for an expedited Mobile Internet Protocol handoff by allowing a mobile station that is engaged in a communication session with a first access network to obtain Internet Protocol connectivity information associated with a second access network via the first access network. A tunnel is then established between the mobile station and the second access network via the first access network based on the Internet Protocol connectivity information and the mobile station obtains Internet Protocol configuration parameters from the second access network via the established tunnel. By obtaining the Internet Protocol configuration parameters associated with the second access network via the first access network instead of waiting until an air interface connection has been established with the second access network, the mobile station may be more expeditiously handed off to the second access network in the event that such a handoff determination is made.

### CROSS-REFERENCE(S) TO RELATED APPLICATION(S)

The present application claims priority from provisional application Ser. No. 60/757,272, entitled “METHOD AND APPARATUS FOR EFFECTING A HANDOFF IN A MOBILE INTERNET PROTOCOL COMMUNICATION SYSTEM,” filed Jan. 9, 2006, which is commonly owned and incorporated herein by reference in its entirety.

### FIELD OF THE INVENTION

The present invention relates generally to Mobile Internet Protocol (Mobile IP) communication systems, and, in particular, to a method and apparatus for effecting a handoff of a packet data communication session from one IP connection to another.

### BACKGROUND OF THE INVENTION

When a mobile station (MS) is engaged in a Mobile IP communication session, the MS is assigned a fixed IP address for the session. A mobility agent of a home network serves as an anchor point for communications with the MS during the communication session and is referred to as the Home Agent. When the MS moves from its home network to a foreign network, the Home Agent tunnels data packets destined for the mobile station to a Care-of-Address (CoA) associated with the mobile station. Typically, the CoA is associated with a mobility agent of the foreign network, that is, a Foreign Agent. Data packets destined for the MS can then be tunneled to the Foreign Agent and, subsequently, to the MS.

Foreign networks advertise their presence to MSs via beacon signals. These beacon signals include an identifier associated with the foreign network, such as a network identifier or an operator identifier. When the MS detects a change in a foreign network through the receipt of the beacon signal, the MS sends a Mobile IP registration request through the new mobility agent to the Home Agent. In other words, the MS is required to establish a connection with the new network via an air interface of the new network, obtain a CoA from the new network, and then convey the CoA to the Home Agent via the connection established with the new network. Typically, the CoA is a CoA of a Foreign Agent associated with the foreign network and the process requires the support of the Foreign Agent. The handoff is, in effect, sequentially constructed with the new network from the bottom layer up, establishing lower layer connectivity with the new network before obtaining higher layer information, such as IP connectivity information such as a CoA. However, sequentially building the connection takes a considerable amount of time, anywhere from 100 milliseconds to 2 seconds, which is generally too slow to support many time sensitive applications, such as Voice over Internet Protocol (VoIP), which requires a faster handoff.

Therefore, a need exists for a method and apparatus that provides for an expedited Mobile IP handoff.

### BRIEF DESCRIPTION OF THE DRAWINGS

FIG. 1 is a block diagram of a wireless communication system in accordance with an embodiment of the present invention.

FIG. 2 is a block diagram of a mobile station of FIG. 1 in accordance with an embodiment of the present invention.

FIG. 3 is a block diagram of an access network of FIG. 1 in accordance with an embodiment of the present invention.

FIG. 4 is a block diagram of a Media Independent Handoff server of FIG. 1 in accordance with an embodiment of the present invention.

FIG. 5 is a signal flow diagram of a method executed by the communication system of FIG. 1 in implementing a handoff in accordance with an embodiment of the present invention.

FIG. 6 is a signal flow diagram of a method executed by the communication system of FIG. 1 in implementing a handoff in accordance with another embodiment of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and apparatus that provides for an expedited Mobile Internet Protocol (IP) handoff, a communication system is provided that provides for an expedited Mobile IP handoff by allowing a mobile station that is engaged in a communication session with a first access network to obtain Internet Protocol connectivity information associated with a second access network via the first access network. A tunnel is then established between the mobile station and the second access network via the first access network based on the Internet Protocol connectivity information and the mobile station obtains Internet Protocol configuration parameters from the second access network via the established tunnel. By obtaining the Internet Protocol configuration parameters associated with the second access network via the first access network instead of waiting until an air interface connection has been established with the second access network, the mobile station may be more expeditiously handed off to the second access network in the event that such a handoff determination is made.

Generally, an embodiment of the present invention encompasses a method for expediting a Mobile IP handoff comprising engaging in a communication session with a first access network, obtaining Internet Protocol connectivity information associated with a second access network via the first access network, establishing a tunnel with the second access network via the first access network based on the Internet Protocol connectivity information, and obtaining Internet Protocol configuration parameters from the second access network via the established tunnel.

Another embodiment of the present invention encompasses a method for expediting a Mobile IP handoff comprising engaging, by a first access network, in a communication session with a mobile station, receiving, by the first access network, a request from the mobile station for Internet Protocol connectivity information associated with a second access network, obtaining the requested Internet Protocol connectivity information, and conveying, by the first access network, the obtained Internet Protocol connectivity information to the mobile station.

Yet another embodiment of the present invention encompasses a mobile station comprising a processor that is configured to engage in a communication session with a first access network, obtain Internet Protocol connectivity information associated with a second access network via the first access network, establish a tunnel with the second access network via the first access network based on the Internet Protocol connectivity information, and obtain Internet Protocol configuration parameters from the second access network via the established tunnel.

Still another embodiment of the present invention encompasses an access network comprising a processor that is configured to engage in a communication session with a mobile station, receive a request from the mobile station for Internet Protocol connectivity information associated with another access network, obtain the requested Internet Protocol connectivity information, and convey the obtained Internet Protocol connectivity information to the mobile station.

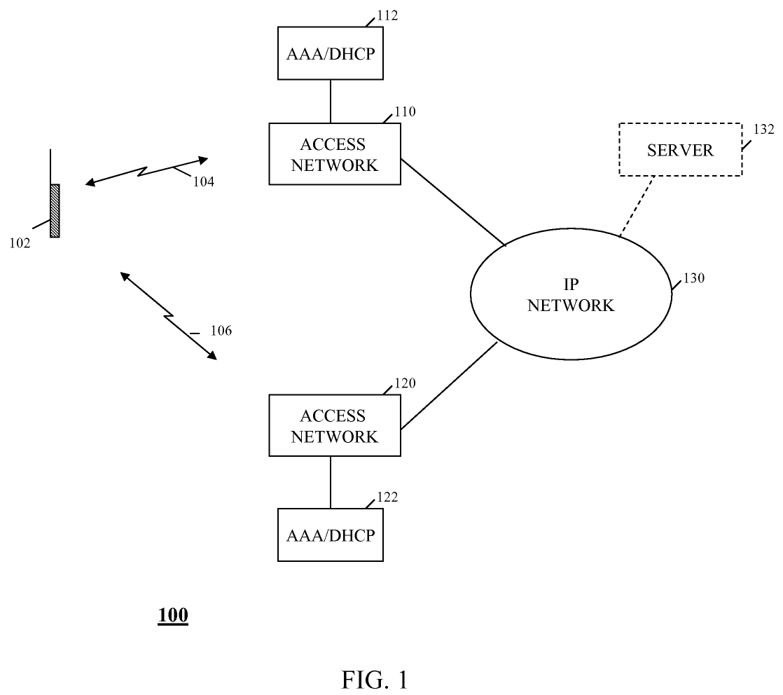

The present invention may be more fully described with reference to FIGS. 1-6. FIG. 1 is a block diagram of a wireless communication system 100 in accordance with an embodiment of the present invention. Communication system 100 is wireless communication system that operates in accordance with the Mobile IP (Internet Protocol) standards promulgated by the Internet Engineering Task Force (IETF), such as the Mobile IPv4 or Mobile IPv6 standards. For example, communication system 100 may comprise a Wireless Local Area Network (WLAN) communication system that operates in accordance with one or more of the IEEE (Institute of Electrical and Electronics Engineers) 802.xx standards, for example, the 802.11, 802.15, 802.16, 802.20, or 802.21 standards. However, those who are of ordinary skill in the art realize that communication system 100 may comprise any one or more cellular communication systems that implement the Mobile IP standards, such as but not limited to a General Packet Radio Service (GPRS) communication system, a Universal Mobile Telecommunication System (UMTS) communication system, a Code Division Multiple Access (CDMA) 2000 communication system, or Fourth Generation (4G) communication systems such as an Orthogonal Frequency Division Multiple Access (OFDM) communication system.

Communication system 100 includes multiple access networks 110, 120 (two shown) that each provides wireless communication services to a respective coverage area serviced by the access network via a respective air interface 104, 106. Each access network of the multiple access networks 110, 120, supports Mobile IP; however, each access network of the multiple access networks 110, 120 may implement a same or a different wireless communication technology as the other access networks of the multiple access networks. For example, one or more of the multiple access networks 110, 120 may comprise a Wireless Local Area Network (WLAN) access point that operates according to a WiFi standard, such as the IEEE (Institute of Electrical and Electronics Engineers) 802.11, 802.15, 802.16, or 802.20 standards. By way of another example, one or more of the multiple access networks 110, 120 may comprise may comprise a WLAN access point that operates according to a WiMAX standard, such as the IEEE 802.21 standard. By way of yet another example, one or more of the multiple access networks 110, 120 may comprise a cellular access network, such as a Base Station (BS) or a Radio Access Network (RAN), that operates according to a cellular communication standard, such as the UMTS or CDMA 2000 standards.

Each access network 110, 120 is coupled to a respective Authentication, Authorization, Accounting/Dynamic Host Configuration Protocol (AAA/DHCP) server 112, 122. However, in another embodiment of the present invention, the functionality of each AAA unit may reside in network entity separate from the entity hosting the functionality of a corresponding DHCP unit. Each access network 110, 120 is further coupled to an IP network 130 and, via the IP network, may be coupled to a web-based server 132 that hosts a database that maintains IP connectivity information, such as AAA and DHCP configuration information associated with each of the multiple access networks 110, 120. Preferably, server 132 comprises a Media Independent Handoff (MIH) server; however one of ordinary skill in the art realizes that server 132 may comprise any web-based server that may be contacted by one access network, such as one of access networks 110 and 120, to obtain IP connectivity information of another access network. In various embodiments of the present invention, IP network 130 may comprise an IP core network, a public IP network (such as the Internet), or both, and one or more of the multiple access networks 110, 120 may be coupled to IP network 130 via a Packet Data Service Node (PDSN) (not shown). Each of air interfaces 104 and 106 includes a forward link and a reverse link. Each forward link includes multiple forward signaling channels and multiple forward traffic channels, and each reverse link includes multiple reverse signaling channels and multiple reverse traffic channels. When the forward link comprises a cellular forward link, the forward link may further include a pilot channel and when the forward link comprises a WLAN forward link, the forward link may further include a beacon channel.

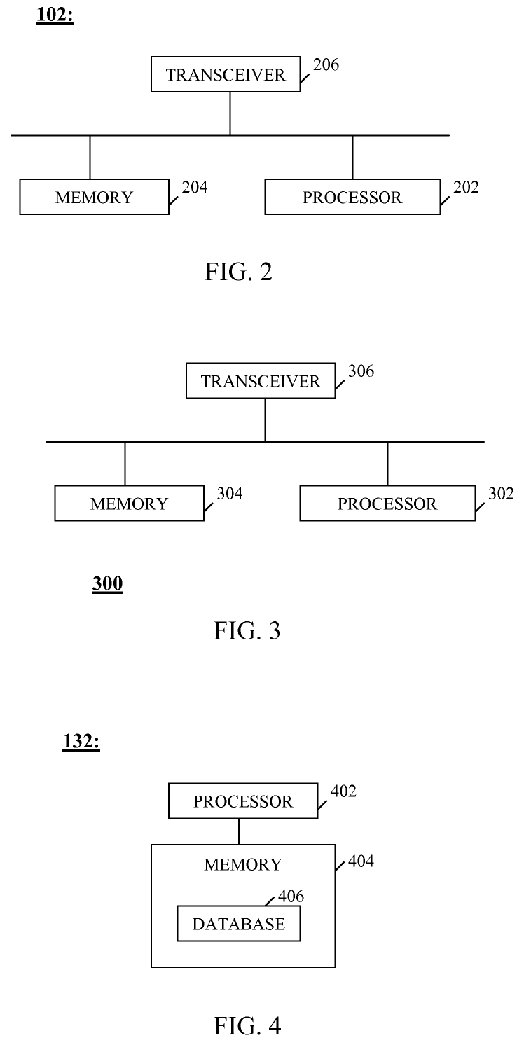

Communication system 100 further includes a wireless mobile station (MS) 102, for example but not limited to a cellular telephone, a radiotelephone, or a Personal Digital Assistant (PDA), personal computer (PC), or laptop computer equipped for wireless communications. MS 102 is a multi-modal MS that is capable of engaging in a Mobile IP communication session over each of air interfaces 104, 106 regardless of the air interface technology employed. Referring now to FIG. 2, a block diagram is provided of MS 102 in accordance with an embodiment of the present invention. MS 102 includes a processor 202, such as one or more microprocessors, microcontrollers, digital signal processors (DSPs), combinations thereof or such other devices known to those having ordinary skill in the art. MS 102 further includes at least one memory device 204 associated with processor 202, such as random access memory (RAM), dynamic random access memory (DRAM), and/or read only memory (ROM) or equivalents thereof, that maintain data and programs that may be executed by the processor and that allow the MS to perform all functions necessary to operate in communication system 100. MS 102 further includes one or more transceivers 206 in communication with processor 202 that receives and transmits signals via each of air interfaces 104 and 106.

FIG. 3 is a block diagram of an access network 300, such as access networks 110 and 120, in accordance with an embodiment of the present invention. Access network 300 includes a processor 302, such as one or more microprocessors, microcontrollers, digital signal processors (DSPs), combinations thereof or such other devices known to those having ordinary skill in the art. Access network 300 further includes an at least one memory device 304 associated with the processor, such as random access memory (RAM), dynamic random access memory (DRAM), and/or read only memory (ROM) or equivalents thereof, that maintains data and programs that may be executed by the corresponding processor and that allows the access network to perform all functions necessary to operate in communication system 100. The at least one memory device 304 of access network 300 further maintains a routing address, such as an IP address, of each of an AAA function and a DHCP function associated with an AAA/DHCP server associated with the access network, such as AAA/DHCP servers 112 and 122, and a routing address, such as an IP address, of server 132. Access network 300 further includes a transceiver 306 in communication with processor 302 that receives and transmits signals via an associated air interface, such as air interfaces 104 and 106.

FIG. 4 is a block diagram of server 132 in accordance with an embodiment of the present invention. Server 132 includes a processor 402, such as one or more microprocessors, microcontrollers, digital signal processors (DSPs), combinations thereof or such other devices known to those having ordinary skill in the art. Server 132 further includes an at least one memory device 404 associated with a corresponding processor, such as random access memory (RAM), dynamic random access memory (DRAM), and/or read only memory (ROM) or equivalents thereof, that maintains data and programs that may be executed by the corresponding processor and that allows the access network and the server to perform all functions necessary to operate in communication system 100. The at least one memory device 404 of server 132 further includes a database 406 that maintains IP connectivity information associated with each access network 110, 120 in communication system 100, such as an IP address, a Domain Name Server (DNS) address, and a default gateway or router associated with the access network and an IP address of each AAA function and a DHCP function associated with the access network. Database 406 of server 132 may further maintain lower layer information, such as bandwidth capabilities, and higher layer information, such as supported services, associated with each access network 110, 120. In one embodiment of the present invention, server 132 may be maintained by an operator of communication system 100. In another embodiment of the present invention, server 132 may be maintained by a third party and an operator of each access network 110, 120 included in communication system 100 may contract with the third party to access, and obtain the services of, server 132.

The embodiments of the present invention preferably are implemented within each of MS 102, access networks 110 and 120, and server 132, and more particularly with or in software programs and instructions stored in the at least one memory devices 204, 304, 404, and executed by the processors 202, 302, 402, of the MS, access networks, and server. However, one of ordinary skill in the art realizes that the embodiments of the present invention alternatively may be implemented in hardware, for example, integrated circuits (ICs), application specific integrated circuits (ASICs), and the like, such as ASICs implemented in one or more of MS 102, access networks 110 and 120, and server 132, and all references to ‘means for’ herein may refer to any such implementation of the present invention. Based on the present disclosure, one skilled in the art will be readily capable of producing and implementing such software and/or hardware without undo experimentation.

In communication system 100, when MS 102 is engaged in a Mobile IP communication session, the MS is assigned a home address, that is, a fixed IP address, for the session. A home network mobility agent serves as an anchor point for communications with MS 102 during the communication session. When the MS roams among different networks, for example, among access networks 110 and 120, Mobile IP allows MS 102 to keep the same IP address and routes data packets intended for the MS to a Care-of-Address (CoA) associated with the MS, thus ensuring that traffic always flows to a current location of the MS and that the MS can continue its communication session while roaming without the session being dropped. Furthermore, since the mobility functions of mobile IP are performed at the network layer instead of the physical layer, MS 102 can roam among networks implementing different air interface technologies while maintaining connections on an on-going application.

In the prior art, when an MS roams from a current, serving network to a new, target network, a handoff to the target network is achieved by establishing a Physical Layer connection with the target network, authenticating with the target network, and obtaining a Care-of-Address (CoA) in the target network via the established Physical Layer connection. The MS then conveys the CoA to the Home Agent via the target network. This process takes a considerable amount of time and is generally too slow to support many time sensitive applications, such as Voice over Internet Protocol (VoIP), which requires a faster handoff. In order to reduce handoff latency, communication system 100 provides for an MS to obtain higher layer (Layer 3 and above) configuration parameters associated with, and to negotiate higher layer connections to, the target network prior to a determination to handoff to the target network and an establishment of lower layer connections with the target network. By obtaining higher layer configuration parameters and negotiating higher layer connections prior to initiating the lower layer handoff connections, a Mobile IP handoff may be expedited and the latency involved in a Mobile IP handoff is reduced.

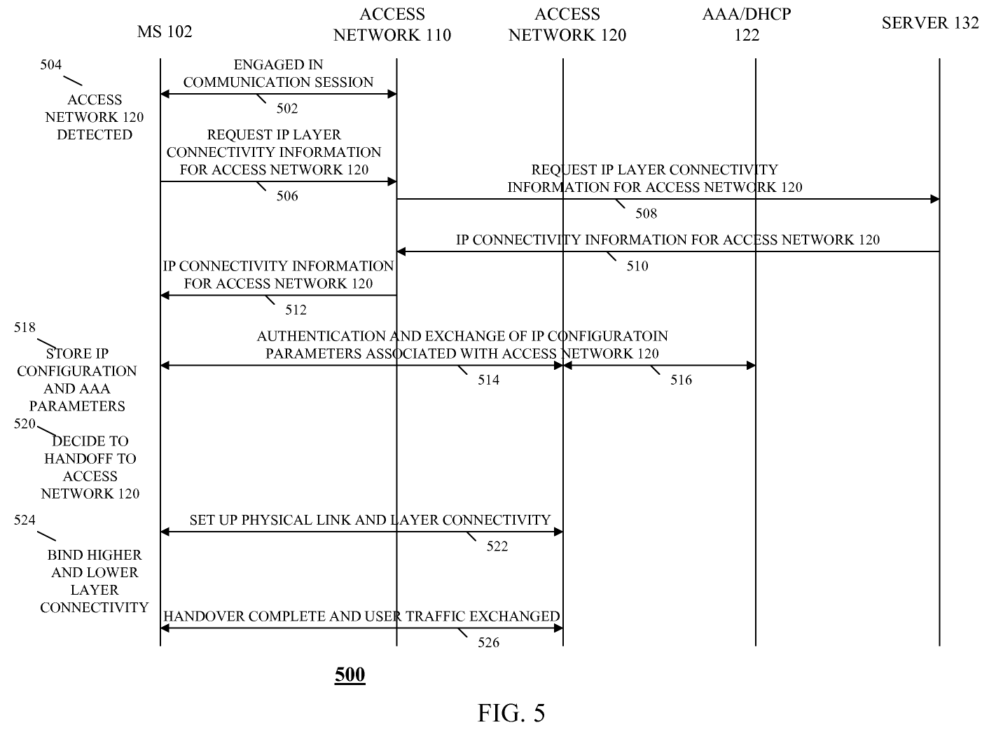

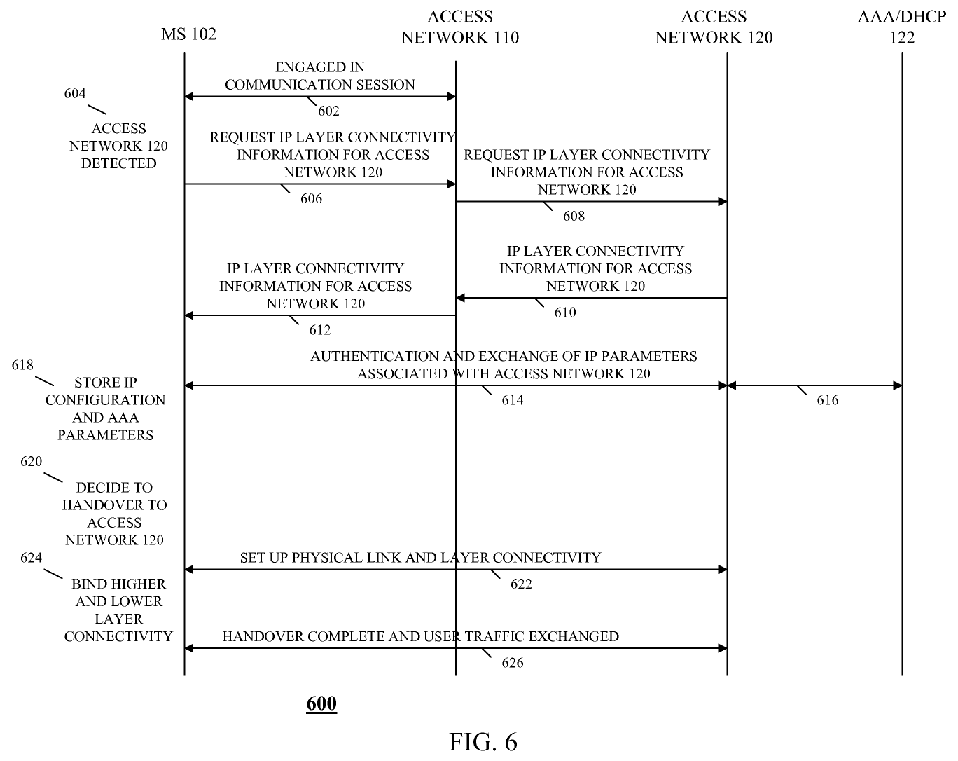

Referring now to FIG. 5, a signal flow diagram 500 is provided that depicts a Mobile IP handoff executed by communication system 100 in accordance with an embodiment of the present invention. Signal flow diagram 500 begins when MS 102 is currently engaged 502 in a Mobile IP communication session and is residing in a coverage area of a first access network, such as access network 110. First access network 110 may comprise a home network of the MS or may comprise a foreign network to which the MS has roamed while engaged in the communication session. While residing in the coverage area of first access network 110, MS 102 detects 504 an existence of a neighboring access network, such as access network 120. In one embodiment of the present invention, MS 102 may detect a channel, such as a beacon channel or a pilot channel, associated with a second, neighboring access network, such as access network 120. Typically, a beacon channel or a pilot channel will include a network identifier or an operator identifier that identifies the network associated with the signal. MS 102 may further determine a quality metric, such as a signal strength, a signal-to-noise ratio (SNR), a carrier-to-interference ratio (C/I), pilot power-to-total power (Ec/Io) ratio, a bit error rate (BER), or a frame error rate (FER), associated the detected channel. MS 102 further monitors a similar channel, such as a beacon channel or a pilot channel, associated with currently serving access network 110 and further determines a quality metric with respect such monitored channel. In other embodiments of the present invention, MS 102 may detect the existence of the neighboring access network, that is, access network 120, whenever the MS feels confident that the neighboring access network exists and the MS knows the identifier associated with the neighboring access network. For example, MS 102 may detect neighboring access network 120 based on user input, such as a user command to connect to the neighboring access network and wherein an identifier of the neighboring access network, such as a network or operator identifier, is maintained in the at least one memory device 204 of the MS, or based on a preconfigured neighbor list received from the current serving access network or from any source external to the MS.

In response to detecting the existence of second access network 120, MS 102 conveys 506, via the reverse link of air interface 104, a request to first access network 110 for IP connectivity information, that is, Layer 3 information, associated with second access network 120. For example, in various embodiments of the present invention, MS 102 may convey the request in response to detecting the channel associated with second access network 120, in response to determining that a quality of the detected channel associated with second access network 120 compares favorably to a corresponding quality threshold, for example, when a signal strength or an SNR exceeds a corresponding signal strength or SNR threshold, and/or in response to determining that a quality of the channel associated with first access network 110 compares unfavorably to a corresponding quality threshold. Preferably these thresholds are different, in level, from any handoff thresholds employed by the MS, thereby permitting the MS to convey the request prior to the MS determining that a handoff is appropriate. In other words, MS 102 may convey the request whenever the MS determines, by reference to an algorithm maintained in the at least one memory device 204 of the MS, that detected access network 120 is a potential handoff target, whether due to a quality of a detected signal of the detected access network or due to a quality of a detected signal of current serving access network 110 or due to both. One of ordinary skill in the art realizes that many possible algorithms may be used to determine whether to convey the request without departing from the spirit and scope of the present invention.

As is known in the art, a layered representation of protocols is commonly known as a protocol stack. A protocol stack typically includes at least five layers, which layers are, from highest to lowest, an Application Layer, a Transport Layer, a Network Layer, a Link Layer, and a Physical Layer. The bottom layer, that is, the Physical Layer, includes the network hardware and a physical medium for the transportation of data. The next layer up is the Link Layer, or Layer 2, which implements protocols that assure a reliable transmission of data in a communication system that guarantees delivery of data. Layer 3, or the Network Layer, is responsible for delivering data across a series of different physical networks that interconnect a source of the data and a destination for the data. Routing protocols, for example, IP protocols such as TPv4 or TPv6, are included in the network layer. An IP data packet exchanged between peer network layers includes an IP header containing information for the IP protocol and data for the higher level protocols. The IP header includes a Protocol Identification field and further includes transport addresses, typically IP addresses, corresponding to each of a transport layer sourcing the data packet and a transport layer destination of the data packet. A transport address uniquely identifies an interface that is capable of sending and receiving data packets to transport layers via the network layer and is described in detail in IETF RFC (Request for Comments) 1246. The IP Protocol is defined in detail in IETF RFC 791.

In response to receiving the request from MS 102 for IP connectivity information associated with second access network 120, first access network 110 conveys 508 a request for the IP connectivity information to server 132. In response to receiving the request from first access network 110, server 132 retrieves, from database 406, the requested IP connectivity information associated with second access network 120 and conveys 510 a message comprising the retrieved IP connectivity information to first access network 110. The retrieved and conveyed IP connectivity information includes the Layer 3 information required for MS 102 to authenticate itself with second access network 120 and to perform upper layer (Layer 3 and up) negotiations for a connection with the second access network. For example, the retrieved and conveyed IP connectivity information associated with second access network 120 may include routing addresses, that is, IP addresses, associated with each of an AAA functionality and a DHCP functionality of AAA/DHCP server 122. The retrieved and conveyed information may further include lower layer information, such as bandwidth capabilities, and higher layer information, such as supported services, associated with second access network 120.

Preferably the message conveyed by server 132 to first access network 110 comprises a modified version of an IEEE 802.21 MIH Information Server (IS) message, which message is modified to include a DHCP address data field and an AAA address data field. The DHCP address data field comprises a DHCP IP address of a DHCP function associated with second access network 120, that is, an IP address associated with the DHCP functionality of AAA/DHCP server 122 that can be contacted by MS 102 to acquire a CoA associated with second access network 120. In the case of IPv6, this address may comprise an All_DHCP_Relay_Agents_and_Servers link local multicast address as defined in DHCPv6. The AAA address data field comprises an IP address associated with the AAA functionality of AAA/DHCP server 122, which address can be contacted by MS 102 to authenticate itself with second access network 120.

In response to receiving the message from server 132, first access network 110 forwards 512 the received information to MS 102 via the forward link of air interface 104. Using the IP connectivity information obtained from server 132, MS 102 establishes a tunnel with the second access network 120 via air interface 104 and first access network 110. MS 102 then performs 514, 516 upper layer negotiations with second access network 120 via the established tunnel, such as a Point-to-Point Protocol (PPP) negotiation and/or an AAA negotiation whereby MS 102 authenticates itself with the AAA functionality of AAA/DHCP server 122 and acquires IP configuration parameters and AAA parameters from the second access network, such as a CoA address from the DHCP functionality of AAA/DHCP server 122 that may be used for a tunneling of data packets to MS 102 when the MS is serviced by second access network 120. MS 102 then stores 518 the received IP configuration parameters and AAA parameters in the at least one memory device 204 of the MS. Thus MS 102 acquires the IP connectivity information and engages in the upper layer negotiations and without establishing a Physical Layer and Link Layer connection over air interface 106.

Subsequent to performing the Point-to-Point Protocol (PPP) negotiation and/or AAA negotiation with second access network 120, MS 102 determines 520 to handoff the communication session from first access network 110 to the second access network. MS 102 then engages 522 in a handoff negotiation with second access network 120 via air interface 106 associated with the second access network and in accordance with well-known handoff techniques in order to establish a Physical Layer and Link Layer connection with the access network, such as obtaining a channel assignment and negotiating a quality of service. However, as MS 102 has already been authenticated with AAA/DHCP server 122 and has already obtained higher level IP configuration parameters from second access network 120, such as a CoA address associated with the second access network, the Physical Layer and Link Layer connections may be bound 524 with higher layer connections without a need to now contact AAA/DHCP server 122. The handoff of MS 102 from first access network 110 to second access network 120 is then completed 526 in accordance with well-known techniques and the MS may receive and transmit data packets via the second access network and the CoA obtained by the MS from AAA/DHCP server 122.

In another embodiment of the present invention, MS 102 may obtain the IP connectivity parameters based on peer-to-peer query/response signaling with second access network 120 instead of based on a query of server 132. FIG. 6 is a signal flow diagram 600 depicting a Mobile IP handoff executed by communication system 100 in accordance with the another embodiment of the present invention. Similar to signal flow diagram 500, signal flow diagram 600 begins when MS 102 is currently engaged 602 in a Mobile IP communication session and is residing in a coverage area of a first access network, such as access network 110. Again, first access network 110 may comprise a home network of the MS or may comprise a foreign network to which the MS has roamed while engaged in the communication session. While residing in the coverage area of first access network 110, MS 102 detects 604 an existence of a neighboring access network, such as access network 120. Similar to signal flow diagram 500, in one embodiment of the present invention MS 102 may detect a channel, such as a beacon channel or a pilot channel, associated with a neighboring access network, such as access network 120. MS 102 may further determine a quality metric associated the detected channel. MS 102 further monitors a similar channel, such as a beacon channel or a pilot channel, associated with currently serving access network 110 and further determines a quality metric with respect such monitored channel. In other embodiments of the present invention, MS 102 may detect the existence of the neighboring access network, that is, access network 120, whenever the MS feels confident that the neighboring access network exists and the MS knows the identifier associated with the neighboring access network.

In response to detecting the existence of second access network 120, MS 102 conveys 606 a request to first access network 110 for IP connectivity information, that is, Layer 3 information, associated with second access network 120. For example, in various embodiments of the present invention, MS 102 may convey the request in response to detecting the channel associated with second access network 120, or MS 102 may convey the request in response to the MS determining that a quality of the channel associated with second access network 120 compares favorably to a corresponding quality threshold, for example, when a signal strength or an SNR exceeds a corresponding signal strength or SNR threshold, and/or in response to the MS determining that a quality of the channel associated with first access network 110 compares unfavorably to a corresponding quality threshold. Similar to signal flow diagram 500, preferably these thresholds are different, in level, from any handoff thresholds employed by the MS, thereby permitting the MS to convey the request prior to the MS determining that a handoff is appropriate. In other words, similar to signal flow diagram 500, MS 102 may convey the request whenever the MS determines, by reference to an algorithm maintained in the at least one memory device 204 of the MS, that detected access network 120 is a potential handoff target, whether due to a quality of a detected signal of the detected access network or due to a quality of a detected signal of current serving access network 110 or due to both.

Preferably the request conveyed by MS 102 to first access network 110 is a modified version of a CARD (Candidate Access Router Discovery protocol) Request or of a request of any similar protocol, which request is modified to include an extension(s) comprising a request for IP connectivity information associated with the second access network. In response to receiving the request from MS 102, first access network 110 conveys 608 a request for the IP connectivity information to second access network 120, again using a CARD Request that is modified as described above. In response to receiving the request from first access network 110, second access network 120 retrieves the requested information and conveys 610 a message comprising the requested information to first access network 110.

Preferably the message conveyed by second access network 120 to first access network 110 is a modified version of a CARD Reply or of a messsage of any similar protocol, which message is modified to include an extension(s) comprising the requested information, such as being modified to include a DHCP address data field and an AAA address data field that respectively provide an IP address of a DHCP functionality and an AAA functionality associated with second access network 120. For example, the information provided by second access network 120 may include the Layer 3 information required for MS 102 to authenticate itself with second access network 120 and for MS 102 to perform upper layer (Layer 3 and up) negotiations for a connection with the second access network, such as an IP address associated with each of an AAA functionality and a DHCP functionality of AAA/DHCP server 122. The provided information may further include lower layer information, such as bandwidth capabilities, and higher layer information, such as supported services, associated with second access network 120.

In response to receiving the message from second access network 120, first access network 110 forwards 612 the received information to MS 102 via the forward link of air interface 104. Using the IP connectivity information obtained from second access network 120, MS 102 establishes a tunnel with the second access network 120 via air interface 104 and first access network 110. MS 102 then performs 614, 616 upper layer negotiations with second access network 120 via the established tunnel, such as a Point-to-Point Protocol (PPP) negotiation and/or an AAA negotiation whereby MS 102 authenticates itself with the AAA functionality of AAA/DHCP server 122 and acquires IP configuration parameters and AAA parameters from the second access network, such as a CoA address from the DHCP functionality of AAA/DHCP server 122 that may be used for a tunneling of data packets to MS 102 when the MS is serviced by second access network 120. MS 102 then stores 618 the received IP configuration parameters and AAA parameters in the at least one memory device 204 of the MS. Thus MS 102 acquires the IP connectivity information and engages in the upper layer negotiations without establishing a Physical Layer and Link Layer connection over air interface 106.

Subsequent to performing the Point-to-Point Protocol (PPP) negotiation and/or AAA negotiation with second access network 120, MS 102 determines 620 to handoff the communication session from first access network 110 to second access network 120. MS 102 then engages 622 in a handoff negotiation with second access network 120 via air interface 106 associated with the second access network and in accordance with well-known handoff techniques in order to establish a Physical Layer and Link Layer connection with the second access network, such as obtaining a channel assignment and negotiating a quality of service. However, as MS 102 has already been authenticated with AAA/DHCP server 122 and has already obtained higher level IP connectivity information from second access network 120, such as a CoA address associated with the second access network, the Physical Layer and Link Layer connections may be bound 624 with higher layer connections without the need to now contact AAA/DHCP server 122. The handoff of MS 102 from first access network 110 to second access network 120 is then completed 626 in accordance with well-known techniques and the MS may receive and transmit data packets via second access network 120 and the CoA obtained by the MS from AAA/DHCP server 122.

By permitting MS 102, when engaged in a communication session with a first access network, that is, access network 110, to obtain IP connectivity information associated with a second access network, that is, access network 120, via the first access network, the MS may be more expeditiously handed off to the second access network in the event that such a handoff determination is made. MS 102 may obtain the obtain IP connectivity information associated with second access network 120 from a web-based server, or may obtain the IP connectivity information based on peer-to-peer query/response signaling with second access network. A tunnel is then established between MS 102 and second access network 120 via first access network 110 based on the IP connectivity information, and the MS obtains IP configuration parameters from the second access network via the established tunnel. By obtaining the IP configuration parameters associated with second access network 120 via first access network 110 instead of waiting until an air interface connection has been established with the second access network, MS 102 may be more expeditiously handed off to the second access network in the event that a handoff determination is made.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for expediting a Mobile Internet Protocol handoff comprising:
engaging in a communication session with a first access network;
obtaining Internet Protocol connectivity information associated with a second access network via the first access network;
establishing a tunnel with the second access network via the first access network based on the Internet Protocol connectivity information; and
obtaining Internet Protocol configuration parameters from the second access network via the established tunnel.

2. The method of claim 1, wherein the Internet Protocol connectivity information comprises one or more of an Internet Protocol address of an Authentication, Authorization, Accounting function associated with a second access network and an Internet Protocol address of an Dynamic Host Configuration Protocol function associated with the second access network.

3. The method of claim 1, wherein obtaining Internet Protocol connectivity information comprises obtaining Internet Protocol connectivity information from a Media Independent Handoff server via the first access network.

4. The method of claim 1, wherein obtaining Internet Protocol connectivity information comprises obtaining Internet Protocol connectivity information from the second access network via the first access network.

5. The method of claim 1, wherein the Internet Protocol configuration parameters comprise a Care-of-Address associated with the second access network.

6. The method of claim 1, further comprising authenticating with the second access network via the established tunnel.

7. The method of claim 1, further comprising determining to handoff to the second access network subsequent to obtaining the Internet Protocol configuration parameters from the second access network.

8. The method of claim 7, further comprising:
negotiating a Point-to-Point connection with the second access based on the obtained Internet Protocol connectivity information and prior to determining to handoff to the second access network;
in response to determining to handoff to the second access network, establishing Physical Layer and Link Layer connectivity with the second access network; and
binding higher layer connectivity to the established Physical Layer and Link Layer connectivity.

9. A method for expediting a Mobile Internet Protocol handoff comprising:
engaging, by a first access network, in a communication session with a mobile station;
receiving, by the first access network, a request from the mobile station for Internet Protocol connectivity information associated with a second access network;
obtaining the requested Internet Protocol connectivity information; and
conveying, by the first access network, the obtained Internet Protocol connectivity information to the mobile station.

10. The method of claim 9, wherein the Internet Protocol connectivity information comprises one or more of an Internet Protocol address of an Authentication, Authorization, Accounting function associated with a second access network and an Internet Protocol address of an Dynamic Host Configuration Protocol function associated with the second access network.

11. The method of claim 9, wherein obtaining the requested Internet Protocol connectivity information comprises:
conveying a request to a Media Independent Handoff (MIH) server for the Internet Protocol connectivity information; and
receiving a message from the MIH server comprising the Internet Protocol connectivity information.

12. The method of claim 9, wherein obtaining the requested Internet Protocol connectivity information comprises:
conveying a request to the second access network for the Internet Protocol connectivity information; and
receiving a message from the second access network comprising the Internet Protocol connectivity information.

13. The method of claim 9, further comprising tunneling Internet Protocol configuration parameters from the second access network to the mobile station.

14. A mobile station comprising a processor that is configured to engage in a communication session with a first access network, obtain Internet Protocol connectivity information associated with a second access network via the first access network, establish a tunnel with the second access network via the first access network based on the Internet Protocol connectivity information, and obtain Internet Protocol configuration parameters from the second access network via the established tunnel.

15. The mobile station of claim 14, wherein the Internet Protocol connectivity information comprises one or more of an Internet Protocol address of an Authentication, Authorization, Accounting function associated with a second access network and an Internet Protocol address of an Dynamic Host Configuration Protocol function associated with the second access network.

16. The mobile station of claim 14, wherein the processor is configured to obtain Internet Protocol connectivity information by obtaining Internet Protocol connectivity information from a Media Independent Handoff server via the first access network.

17. The mobile station of claim 14, wherein the processor is configured to obtain Internet Protocol connectivity information by obtaining Internet Protocol connectivity information from the second access network via the first access network.

18. The mobile station of claim 14, wherein the Internet Protocol configuration parameters comprise a Care-of-Address associated with the second access network.

19. The mobile station of claim 14, the processor is further configured to authenticate the mobile station with the second access network via the established tunnel.

20. The mobile station of claim 14, the processor is further configured to determine to handoff to the second access network subsequent to obtaining the Internet Protocol configuration parameters from the second access network.

21. The mobile station of claim 20, the processor is further configured to negotiate a Point-to-Point connection with the second access network based on the obtained Internet Protocol connectivity information and prior to determining to handoff to the second access network, to establish Physical Layer and Link Layer connectivity with the second access network in response to determining to handoff to the second access network, and to binding higher layer connectivity to the established Physical Layer and Link Layer connectivity.

22. An access network comprising a processor that is configured to engage in a communication session with a mobile station, receive a request from the mobile station for Internet Protocol connectivity information associated with another access network, obtain the requested Internet Protocol connectivity information, and convey the obtained Internet Protocol connectivity information to the mobile station.

23. The access network of claim 22, wherein the Internet Protocol connectivity information comprises one or more of an Internet Protocol address of an Authentication, Authorization, Accounting function associated with an another access network and an Internet Protocol address of an Dynamic Host Configuration Protocol function associated with the another access network.

24. The access network of claim 22, wherein the processor is configured to obtain the requested Internet Protocol connectivity information by conveying a request to a Media Independent Handoff (MIH) server for the Internet Protocol connectivity information and receiving a message from the MIH server comprising the Internet Protocol connectivity information.

25. The access network of claim 22, wherein the processor is configured to obtain the requested Internet Protocol connectivity information by conveying a request to the second access network for the Internet Protocol connectivity information and receiving a message from the second access network comprising the Internet Protocol connectivity information.

26. The access network of claim 22, wherein the processor is configured to tunnel Internet Protocol configuration parameters from the second access network to the mobile station.
